(19) United States
(12) Patent Application Publication
(10) Pub. No.: US 2007/0162516 A1
(43) Pub. Date: Jul. 12, 2007

(54) Computing asynchronous transaction log replication progress based on file change notifications

(75) Inventors: Gregory I. Thiel, Black Diamond, WA (US); Rebecca L. Anderson, Seattle, WA (US); Alexander Robert Norton Wetmore, Seattle, WA (US)

Correspondence Address: SENNIGER POWERS (MSFT), ONE METROPOLITAN SQUARE, 16TH FLOOR, ST. LOUIS, MO, 63102, US

(73) Assignee: Microsoft Corporation, Redmond, WA (US)

(21) Appl. No.: 11/324,003

(22) Filed: Dec. 30, 2005

(51) Int. Cl. G06F 17/30

(52) U.S. Cl. 707/201

(57) ABSTRACT

Asynchronous transaction log replication from a source database to a destination database utilizing file change notifications for a source log directory generated by an operating system of a source computing machine and received by a destination computing machine. In response to the received file change notification, a source transaction log in the source log directory is copied to a destination transaction log in a destination log directory of the destinations machine. After the copy is completed, transactions contained in the destination transaction log are applied to the destination database.

### BACKGROUND

FIG. 1 shows an exemplary asynchronous replication flow for databases. The replication, which is based on copying and moving files between directories, begins on a source machine where a source database creates a transaction log file in a source log directory. The log file contains transactions that have been applied to the source database. Across the machine boundary, a process on a destination machine monitors the source log directory on the source machine. When the process detects that a new log file is available in the source log directory, the new source log file is copied from the source log directory on the source machine to a log inspection directory on the destination machine. If the log passes an inspection process, the log is moved to a destination log directory on the destination machine. Then, the transactions in the log file in the destination log directory are applied to the destination database.

The current status of the log file can be inferred at any point by which files are located in each of the replication directories described above. When the replication system is restarted, it computes the current state of work queues by scanning these directories. It is critical that the replication system accurately tracks the transaction logs in the system because (1) the system should only remove the log file from the source directory on the source machine after it has been applied to the destination database on the destination machine; and (2) the status of the destination database is indicated by the backlog of transaction logs in the source log file directory on the source machine that have not been applied to the destination database. The larger the backlog of transaction log files, the more the destination database is out-of-synchronization with the source database.

Unfortunately, an asynchronous replication solution can have a backlog of data to copy from the source database to the destination database. Because the data typically has a logical sequence, it is important to track the amount of the backlog to understand the latency of the data propagation.

A typical replication solution piggybacks information on communication between source database and destination database. This may require the information to be surfaced to the replication application in a particular manner so that it can be interpreted. Another solution forces monitoring data to be requested by the destination database and provided by the source database. This solution may require a new protocol that operates in a specified manner to be constructed. Either solution may require additional overhead to the applications involved.

### SUMMARY

Embodiments of the invention overcome one or more deficiencies in known asynchronous replication systems by tracking the progress of transaction log replication between a source database and a destination database through file change notifications. According to aspects of the invention, the destination machine receives a file change notification from the operating system of the source machine when a new source transaction log in a transaction log directory is available. The notification permits tracking pending work for the replication system. In response to the file change notification, the source transaction log is copied to a destination transaction log in a destination log directory.

In another aspect, the invention determines asynchronous transaction log replication latency from a source database to a destination database. For example, one embodiment of the invention calculates latency based on the sequence number of a new log compared to the log currently being transported. The operating system of the source machine sends a file change notification when a new source transaction log file is available. By comparing this information to active log information for the destination log file that is currently being applied to the destination database, transaction log latency may be determined.

Computer-readable media having computer-executable instructions for asynchronous transaction log replication embody further aspects of the invention. Alternatively, embodiments of the invention may comprise various other methods and apparatuses.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIG. 1 is an flow diagram illustrating asynchronous replication flow according to the prior art.

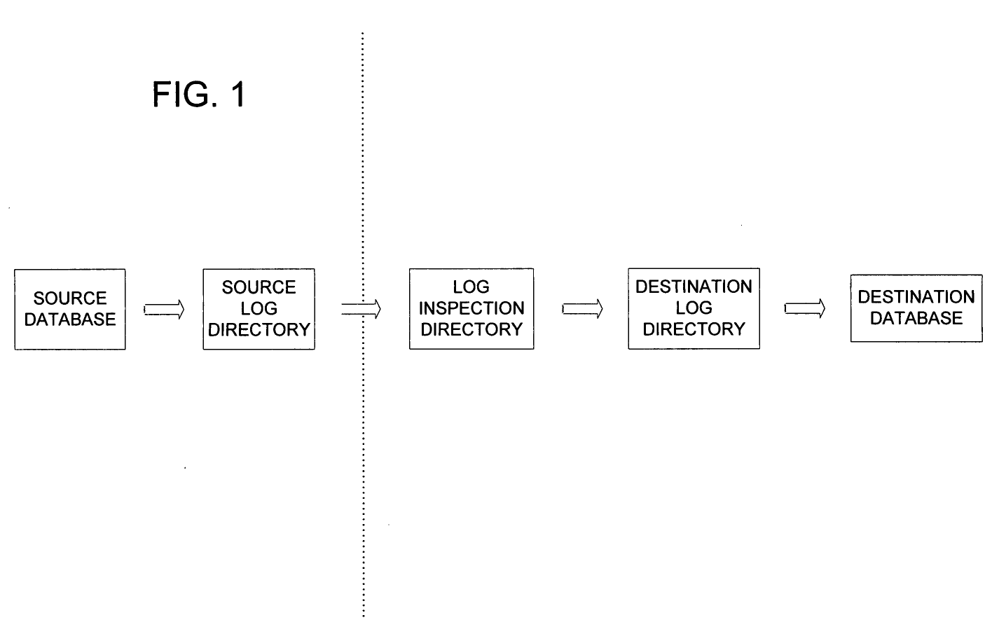

FIG. 2 is a block diagram illustrating a computing system environment for asynchronous transaction replication according to an embodiment of the invention.

FIG. 3 is an exemplary flow diagram illustrating asynchronous replication according to an embodiment of the invention.

FIG. 4 is an exemplary flow diagram illustrating asynchronous replication according to another embodiment of the invention.

FIG. 5 is a block diagram illustrating one example of a suitable computing system environment in which the invention may be implemented.

Corresponding reference characters indicate corresponding parts throughout the drawings.

### DETAILED DESCRIPTION

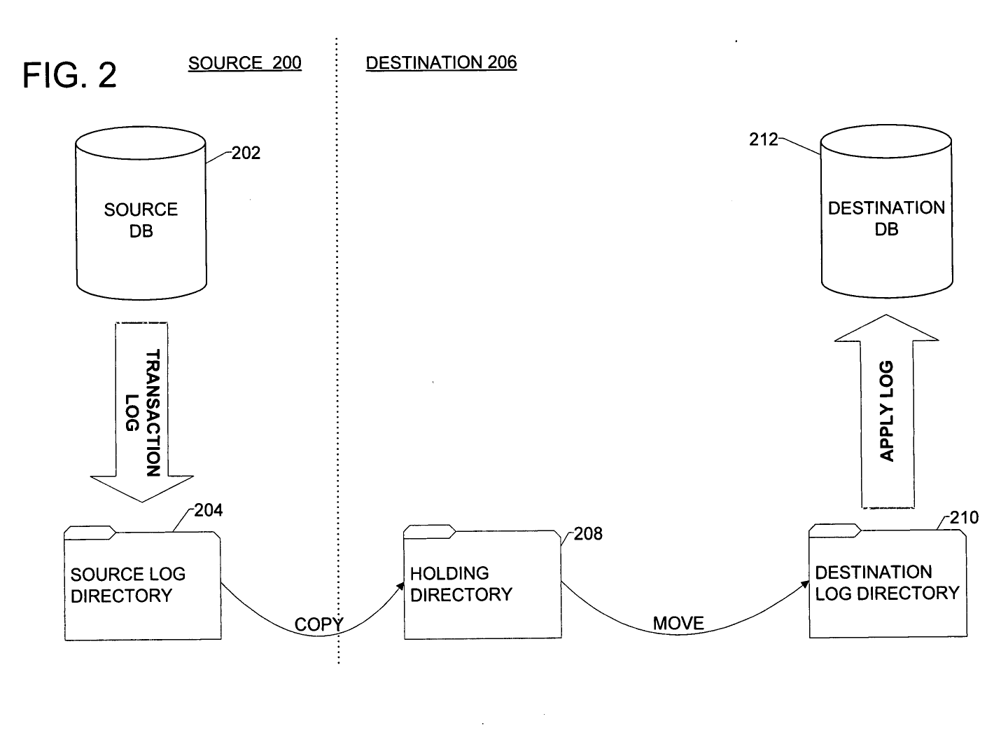

Referring to the drawings, FIG. 2 shows a computer system for tracking progress of an asynchronous transaction log replication according to aspects of the invention. Advantageously, embodiments of the invention leverage available information, such as file notifications and file modification times, to track progress of the replication. This information may be the same information that is used to trigger replicating the next log in sequence.

In the illustrated embodiment, a source machine 200 includes a source database 202 containing transaction information. A transaction may be any record of a change to the source database 202 (e.g., updates, deletions, and the like). In one embodiment, the transactions include: adding records to the database, deleting records from the database, and updating records in the database, and creating new databases. As an example, database software often creates a transaction log file as part of a database backup or recovery process. The transaction file log may also be created as database transactions are applied to the source database 202. In one embodiment, database 202 contains information relating to transactions in an email system. The source database 202 creates the transaction log in a source log directory 204 and, in this embodiment, the transaction log file contains database transactions that were applied to source database 202. The source database 202 can be any database known in the art.

In another embodiment, the transaction log file is referenced to a unique sequence number indicating the order that the transaction logs were created. In this embodiment, log sequence numbers are ordered such that if a second log sequence number is greater than a first log sequence number, the changes recorded in the log file referred to by the second log sequence number occurred after the changes recorded in the log file referred to by the first log sequence number. In yet another embodiment, the transaction log file is referenced by a timestamp indicating the date and time that the log was created.

On a destination machine 206 of FIG. 2, the asynchronous replication process subscribes to file change notifications for the source log directory 204. The process receives file change notifications whenever a new source log file is available in the source log directory 204. The new source log file is copied to a holding directory 208 on the destination machine 206. In one embodiment, the destination machine 206 is the same machine as the source machine 200. In another, the destination machine 206 is not the same machine as the source machine 200. After the log is copied, destination machine 206 verifies and inspects the copy for errors. If destination machine 206 finds the log to be valid, it moves the log from the holding directory 208 to a destination log directory 210. The process then applies the transactions in the transaction log file in the destination log directory 210 to a destination database 212.

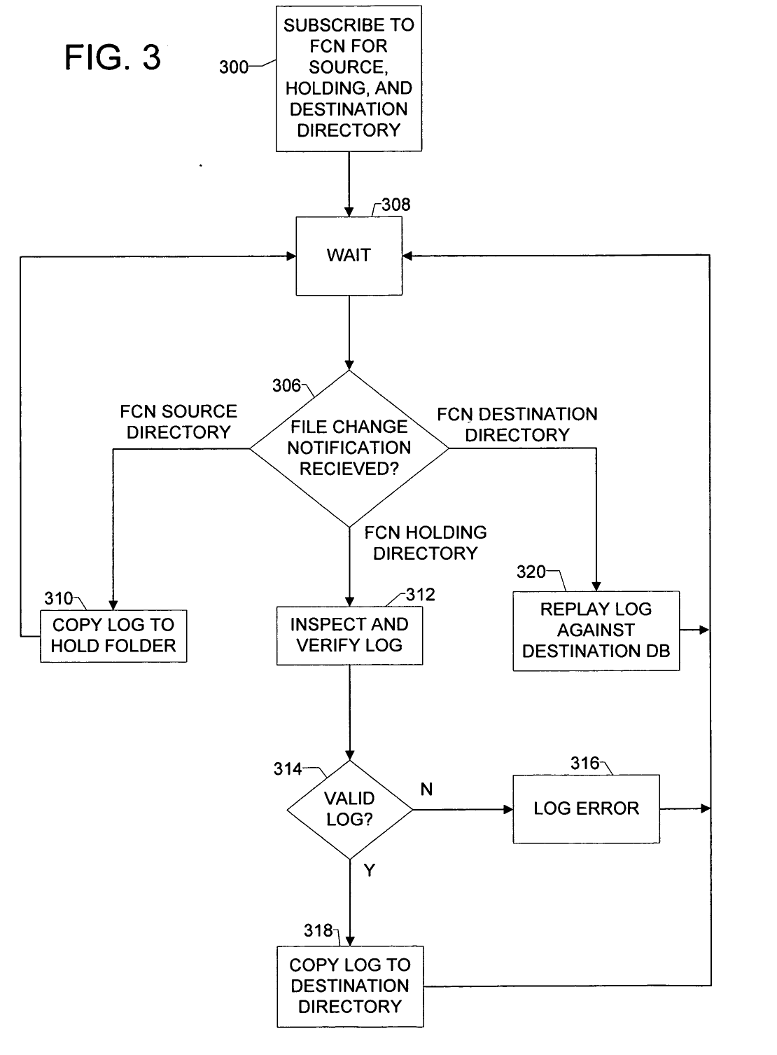

FIG. 3 illustrates an exemplary method of one embodiment of the invention. At 300, an asynchronous replication process on destination machine 206 subscribes to file change notifications for source log directory 204 on the source machine 200 and subscribes to file change notification for the destination log directory 210 and holding directory 208 on the destination machine 206. In one embodiment, the destination machine 206 is the same machine as the source machine 200. In another embodiment, the destination machine 206 is not the same machine as the source machine 200. The source log directory 204 may contain one or more transaction log files. The transaction log file contains, for example, transactions that have been applied to source database 202. In one embodiment, the file change notifications are part of a service provided by an operating system. In this embodiment, the operating system service sends a notification to a subscribed application whenever files changes have occurred within the subscribed directory. Because the file change notification are provided by the operating system and not the source database 202, no new protocol needs to be developed.

In another embodiment, the asynchronous replication process polls source log directory 204, the holding directory 208, and the destination log directory 210 for any existing transaction logs. Because the file system notification service only sends a notification when a change has occurred to a directory, the asynchronous replication process will not be notified through the subscription of any log files existing in source file directory 204, the holding directory 208, and the destination log directory 210 before the subscription began. The asynchronous replication process determines if any existing transaction log files are available in source log directory 204, the holding directory 208, and the destination log directory 210. If no logs are available, operation proceeds to 308 to wait for a file change notification to be received. On the other hand, if at least one transaction log is available in the source log directory 204, the process continues at 310. If at least one transaction log is available in the holding directory 208, the process continues at 312. And, if at least one transaction log is available in the destination log directory 210, the process continues at 320.

If a file change notification for the source log directory is received at 306, the available transaction log is copied to holding directory 208 at 310. In one embodiment, the holding directory 208 is a temporary location on destination machine 206 where transaction log files are copied from the source log directory 204 from source machine 202. After the transaction log file is copied, the process waits at 308 for the next file change notification.

If a file change notification for the holding directory 208 is received at 306, the process inspects the transaction log and verifies it at 312. If the log file is found to be invalid, destination machine 206 initiates an error process at 316. In one embodiment, an error is written to an event log. In another embodiment, the error process includes waiting for a predetermined period of time and retrying the transaction log file copy from source directory 204. If the error cannot be corrected, the asynchronous replication process waits for file change notifications at 308. In another embodiment, if the error is corrected, the process continues on at 318. If destination machine 206 finds the log file to be valid at 314, it moves the log file to the destination log directory 210 at 318. The destination log directory 210 is a location on the destination machine 206. After the transaction log file is moved at 318, the process waits at 308 for the next file change notification.

If a file change notification for the destination log directory 210 is received at 306, at 320 the transactions contained within the log are applied to the destination database 212 on destination machine 206. After the transaction log has been applied to the destination database 212, the process waits for a file change notification at 308. In one embodiment, after the transaction log file is applied to destination database 212, the source log file is deleted from the source log file directory 204 on source machine 200.

As described above, aspects of the present invention take advantage of file change notifications generated by the operating system of source machine 200. Those skilled in the art are familiar with such notifications being generated when files are modified or committed. According to an alternative embodiment of the invention, these notifications trigger the recording of a new log in sequence, which may be used for determining latency in the replication. Because the files being copied are an ordered stream, a new modification indicates that one or more new logs are available. The latency may be calculated based on knowing which new log is available (i.e., its sequence number) as compared to which one is being copied. Advantageously, this embodiment also has the ability to convert this information to a time-based latency by examining modification times on source machine 200.

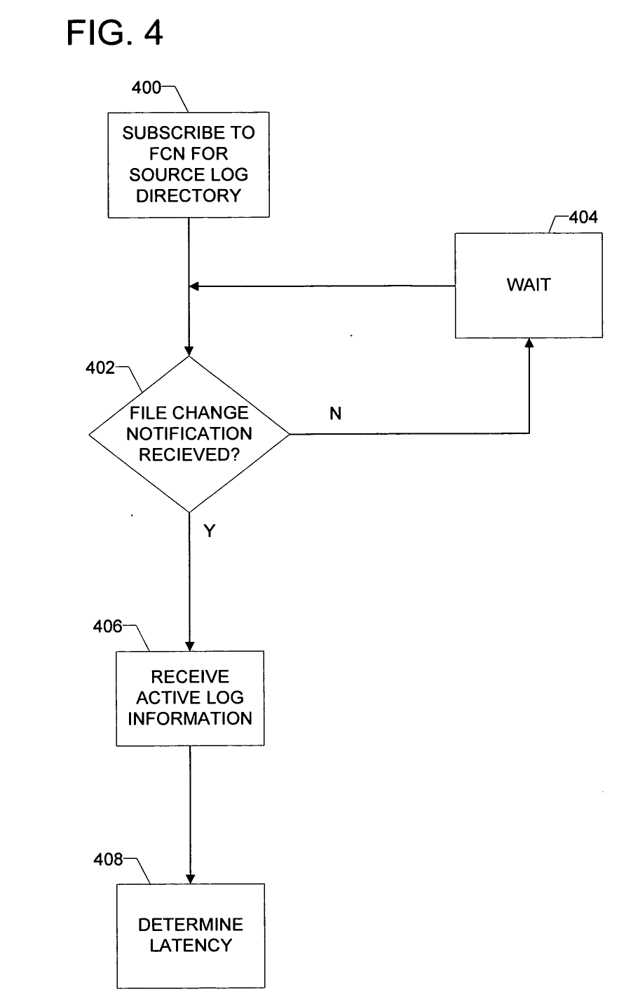

Referring next to FIG. 4, an exemplary latency determining process subscribes to a file change notification for source log directory 204 at 400. At 402, the process determines if a file change notification has been received. If not, the process waits at 404 until the file change notification is received. If the file change notification has been received at 402, the process receives active log information at 406. The active log in this embodiment is the destination transaction log on the destination machine 206 that was copied from source machine 200 and that is currently being applied to destination database 212. In one embodiment, the destination machine 206 may be the same machine as the source machine 200. The active log information may include information such as the log name, log sequence number, or the timestamp of the log file indicating the date and time that the file was created.

At 408, the process determines latency by comparing the information contained in the file change notification to the information from the active log. In one embodiment, the timestamps of the files are compared and the latency is expressed in time. In another embodiment, the sequence number of the log files is compared and the latency is expressed in units of logs.

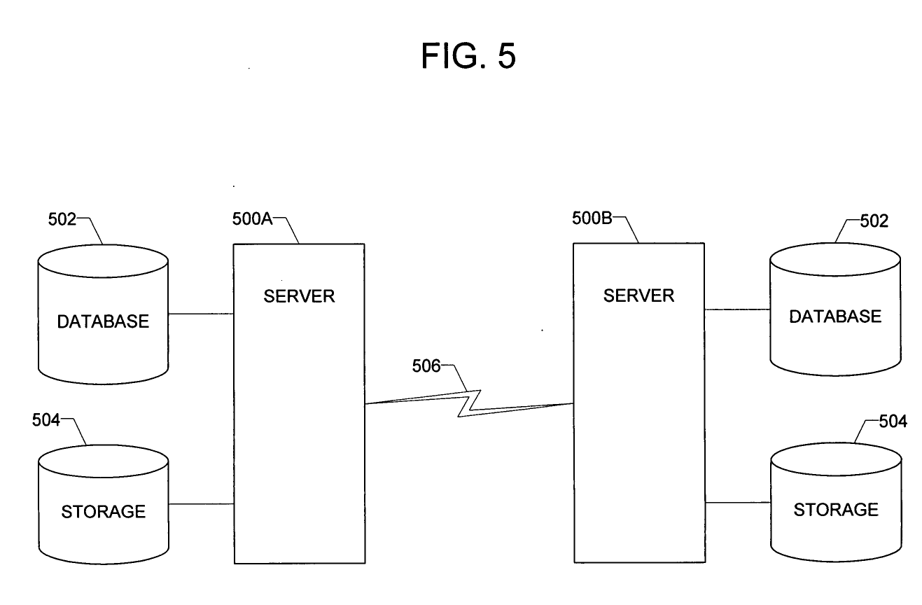

FIG. 5 shows one example of a general purpose computing device in the form of a server 500. In one embodiment of the invention, a computer such as the server 500 is suitable for use in the other figures illustrated and described herein. Server 500 has one or more processors or processing units and a system memory. In the illustrated embodiment, a system bus couples various system components including the system memory to the processors. The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The server 500 typically has at least some form of computer readable media. Computer readable media, which include both volatile and nonvolatile media, removable and non-removable media, may be any available medium that may be accessed by a computing device. By way of example and not limitation, computer readable media comprise computer storage media, such as database 502 and storage 504, and communication media 506. In one embodiment, computer storage media 504 include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by server 500. Communication media 506 typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media 506. Combinations of any of the above are also included within the scope of computer readable media.

The system memory includes computer storage media 504 in the form of removable and/or non-removable, volatile and/or nonvolatile memory. In the illustrated embodiment, system memory includes read only memory (ROM) and random access memory (RAM). A basic input/output system (BIOS), containing the basic routines that help to transfer information between elements within server 500, such as during start-up, is typically stored in ROM. RAM typically contains data and/or program modules that are immediately accessible to and/or presently being operated on by processing unit. By way of example, and not limitation, FIG. 5 illustrates operating system, application programs, other program modules, and program data.

The server 500 may also include other removable/non-removable, volatile/nonvolatile computer storage media 504. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive, and magnetic disk drive and optical disk drive are typically connected to the system bus by a non-volatile memory interface, such as interface.

The drives or other mass storage devices and their associated computer storage media 404 discussed above and illustrated in FIG. 5, provide storage of computer readable instructions, data structures, program modules and other data for the server 500.

A server 500A (e.g., source machine 200) may operate in a networked environment using logical connections to one or more remote computers, such as a server 500B (e.g., destination machine 206). The server 500B may be a personal computer, a server, a router, a network PC, a peer device or other common network node, and typically includes many or all of the elements described above relative to server 500A. The logical connection 506 depicted in FIG. 5 include a local area network (LAN) and a wide area network (WAN), but may also include other networks. LAN and/or WAN may be a wired network, a wireless network, a combination thereof, and so on. Such networking environments are commonplace in offices, enterprise-wide computer networks, intranets, and global computer networks (e.g., the Internet).

Generally, the data processors of server 500 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. Aspects of the invention described herein includes these and other various types of computer-readable storage media when such media contain instructions or programs for implementing the steps described below in conjunction with a microprocessor or other data processor. Further, aspects of the invention include the computer itself when programmed according to the methods and techniques described herein.

For purposes of illustration, programs and other executable program components, such as the operating system, are illustrated herein as discrete blocks. It is recognized, however, that such programs and components reside at various times in different storage components of the computer, and are executed by the data processor(s) of the computer.

Although described in connection with an exemplary computing system environment, including server 500, embodiments of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. Generally, program modules include, but are not limited to, routines, programs, objects, components, and data structures that perform particular tasks or implement particular abstract data types. Aspects of the invention may also be practiced in distributed computing environments where tasks are performed by remote processing devices that are linked through a communications network. In a distributed computing environment, program modules may be located in both local and remote computer storage media including memory storage devices.

An interface in the context of a software architecture includes a software module, component, code portion, or other sequence of computer-executable instructions. The interface includes, for example, a first module accessing a second module to perform computing tasks on behalf of the first module. The first and second modules include, in one example, application programming interfaces (APIs) such as provided by operating systems, component object model (COM) interfaces (e.g., for peer-to-peer application communication), and extensible markup language metadata interchange format (XMI) interfaces (e.g., for communication between web services).

The interface may be a tightly coupled, synchronous implementation such as in Java 2 Platform Enterprise Edition (J2EE), COM, or distributed COM (DCOM) examples. Alternatively or in addition, the interface may be a loosely coupled, asynchronous implementation such as in a web service (e.g., using the simple object access protocol). In general, the interface includes any combination of the following characteristics: tightly coupled, loosely coupled, synchronous, and asynchronous. Further, the interface may conform to a standard protocol, a proprietary protocol, or any combination of standard and proprietary protocols.

The interfaces described herein may all be part of a single interface or may be implemented as separate interfaces or any combination therein. The interfaces may execute locally or remotely to provide functionality. Further, the interfaces may include additional or less functionality than illustrated or described herein.

In operation, server 500 executes computer-executable instructions such as those illustrated in the figures to implement aspects of the invention.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A method of asynchronous transaction log replication from a source database to a destination database, said method comprising:
receiving a file change notification, said file change notification being sent by an operating system of a source computing device associated with the source database, said source computing device maintaining a source transaction log directory, and said file change notification indicating that a new source transaction log is available in the source transaction log directory;
copying, in response to the received file change notification, the source transaction log to a destination transaction log, said destination transaction log being located in a destination transaction log directory; and
applying transactions from the destination transaction log to the destination database, said transactions representing modifications that have been previously applied to the source database.

2. The method of claim 1, wherein the source database is associated with a first computing machine and the destination database is associated with a second computing machine.

3. The method of claim 1 further comprising:
receiving a second file change notification, said second file change notification being sent by the operating system, said second file change notification indicating that a new destination transaction log is available in the destination transaction log directory; and
wherein the applying transactions from the destination transaction log to the destination database is in response to the second file change notification.

4. The method of claim 1 further comprising:
verifying the destination transaction log; and
initiating an error procedure if said destination transaction log is found invalid during verification such that the invalid transaction log is not applied to the destination database.

5. The method of claim 4, wherein the error procedure comprises writing an event to a system event log, said system event log being associated with the destination computing machine, and said event notifying a system administrator of the destination computing machine that an error has occurred.

6. The method of claim 4, wherein the error procedure includes recopying the source transaction log to a new destination transaction log in the destination log directory, said new destination transaction log replacing the invalid destination transaction log.

7. The method of claim 4, wherein verifying the destination transaction log comprises:
copying the source transaction log file to a destination transaction log file in a holding directory on the destination machine, said holding directory being a temporary location for the destination transaction log file; and
moving the destination transaction log from the holding directory to the destination log directory if the destination transaction log is found valid during verification.

8. The method of claim 7 further comprising:
receiving a second file change notification, said second file change notification being sent by the operating system, said second file change notification indicating that a new destination transaction log is available in the holding directory; and
wherein the moving the destination transaction log from the holding directory to the destination log directory is in response to the second file change notification.

9. The method of claim 1, wherein the source database and destination database are associated with an email application.

10. The method of claim 1, wherein the file change notification is generated by a service of the operating system.

11. The method of claim 1, wherein the transactions include one or more of the following: adding records to the database, deleting records from the database, updating records in the database, and creating new databases.

12. The method of claim 1 further comprising:
polling the source transaction log directory for available source transaction log files, said source transaction log files failing to generate the file change notification on the destination system.

13. The method of claim 1, wherein one or more computer-readable media have computer-executable instructions for performing the method of claim 1.

14. A method for determining asynchronous transaction log replication latency from a source database to a destination database, said method comprising:
receiving a file change notification from a file change notification service, said file change notification service being associated with an operating system of a source computing device, said file change notification indicating that a new source transaction log is available in a source transaction log directory, said source transaction log directory being maintained by a source computing device, said transaction log being associated with the source database and containing transactions, said transactions representing modifications that have been previously applied to the source database;
receiving active log information, said active log information relating to a destination transaction log that is being applied to the destination database, and said destination transaction log being previously copied from a source transaction log in response to a previous file change notification; and
determining the transaction log replication latency by comparing the file change notification to the active log information.

15. The method of claim 14, wherein the source transaction logs are created in a sequence, said sequence representing the order that transactions were applied to the source database.

16. The method of claim 15, wherein the sequence of the source transaction file is represented by a sequence number and the transaction log latency is determined by comparing the sequence number of the active log information to the sequence number of the source log file.

17. The method of claim 16, wherein the transaction log latency is expressed in units of logs such that the sequence number of the source transaction log is subtracted from the sequence number of the active log information.

18. The method of claim 15, wherein the sequence of the source transaction file is represented by a modification date and the transaction log latency is determined by comparing the modification date of the active log information to the modification date of the source log file.

19. A system for asynchronous transaction log replication from a source database to a destination database, the system comprising:
a file change notification for a source transaction log directory, said file change notification being provided by an operating system, said source transaction log directory being maintained by the operating system and containing a source transaction log, said source transaction log containing transactions relating to the source database, and said file change notification indicating that a new source transaction log is available in the source transaction log directory;
a destination transaction log directory;
a destination transaction log located in the destination transaction log directory, said destination transaction log being a copy of the source transaction log, said source transaction log being copied in response to a received file change notification; and
wherein the destination database is updated by a transaction contained within the destination transaction log, said transaction representing a modification that has been previously applied to the source database.

20. The system of claim 19, wherein the source database is associated with a first computing machine and the destination database is associated with a second computing machine.
